(19) United States
(12) Patent Application Publication
(10) Pub. No.: US 2002/0036537 A1
(43) Pub. Date: Mar. 28, 2002

(54) Electronic circuit for controlling voltage signals at particular critical nodes, for example of a POR circuit

(76) Inventors: Giovanni Guaitini, Trecella (IT); Marco Pasotti, S. Marino Sicc. (IT); Pier Luigi Rolandi, Monleale (IT)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 09/920,316

(22) Filed: Aug. 1, 2001

(30) Foreign Application Priority Data
Aug. 2, 2000 (IT) MI2000A 001804

(51) Int. Cl. G05F 3/02

(52) U.S. Cl. 327/546; 307/112

(57) ABSTRACT

An electronic circuit for controlling voltage signals at particular critical nodes of an electronic device connected to the circuit, said circuit being inserted between a supply voltage reference and a ground voltage reference, and having at least one internal reference node connected to the critical nodes, and including at least one capacitive element inserted between the supply voltage reference and the ground voltage reference, and connected to the internal reference node through a charging device, said capacitive element being charged with the supply voltage reference to maintain, at the internal reference node, a voltage value above a predetermined threshold voltage as the supply voltage reference is cut off.

### BACKGROUND OF THE INVENTION

1. Field of the Invention

The present invention relates to an electronic circuit for controlling voltage signals at particular critical nodes, for example of a POR (Power-On Reset) circuit.

Specifically, the invention relates to an electronic circuit for controlling voltage signals at particular critical nodes of an electronic device connected to the circuit, said circuit being inserted between a supply voltage reference and a ground voltage reference and having at least one internal reference node connected to said critical nodes.

The invention relates, particularly but not exclusively, to a discharge circuit for critical nodes in power-on circuits, and the following description is made with reference to this application field for convenience of illustration only.

2. Description of the Related Art

As it is well known, a common concern with almost all digital electronic devices is to have the device correctly initialized at power-on.

For this reason, electronic devices are conventionally provided with POR (Power-On Reset) circuits able to sense the moment when a supply voltage Vdd has reached a suitable value for the electronic device to start to operate normally, or conversely, when the supply voltage has dropped below a certain level at which the electronic device turns off.

In particular, the POR circuit controls the insertion of the power supply and resets the digital device using, as its output signal, the supply voltage Vdd until this voltage rises above a certain threshold level at which the circuit output signal would go low.

The switching of the output signal generates a reset signal to the digital device, whereby the device begins to operate only at acceptable values of the supply voltage Vdd.

Also known are electronic circuits that sense drops in the supply voltage Vdd. Such circuits are used to warn the digital device of the impending power-off, so that the device can initiate appropriate operations.

In general, POR circuits arranged to sense variations in the supply voltage Vdd have functional peculiarities that may create problems, not to be incurred with traditional circuits (designed for operation on supply voltages Vdd at rated values).

For example, the rate of change of the supply voltage Vdd can affect the operation threshold of such POR circuit.

A further problem arises because of the drop in the supply voltage Vdd affecting certain nodes, referred to as the critical nodes of the system.

Take for instance a POR circuit 1 as schematically shown in FIG. 1.

The POR circuit 1 is controlled by a circuit 2 comprising two inverters I1 and 12, which are connected in series together between a node A receiving a signal INTPOR, and a node B supplying a signal EN. A further node C interconnecting the two inverters I1 and 12 supplies a signal EN_N.

Each of the inverters I1 and I2 comprises a series of MOS transistors M50, M51, M52 and M53, M54, M55, respectively. In particular, the inverters I1 and I2 shown in FIG. 1 comprise additional transistors, M51 and M54, in comparison with traditional MOS inverters serving a limiter function.

At power-on, the POR circuit 1 should start with the signal INTPOR at the supply voltage Vdd, with the signal EN_N at a ground reference gnd, and the signal EN at the supply voltage Vdd. This is essentially achieved by inserting a coupling capacitor between the supply reference and the node A.

Starting with the above conditions, the POR circuit 1 will perform correctly, that is with the signal INTPOR tending to go even higher, the signal EN_N staying low, and the signal EN tending to go high.

The signals EN and EN_N are used for enabling the power-on reset circuitry. As the supply voltage Vdd reaches the changeover threshold, the signal INTPOR goes low. At this point, the POR circuit has served its duty and is turned off by the signals EN_N (presently high) and EN (presently low) to prevent it from dissipating power.

Such is the final signal setup attained after power-on.

It should be noted, however, that if this setup is missed for a whatever reason, i.e., the signals INTPOR and EN fail to rise with the supply voltage Vdd at power-on, the digital device would at once enter the disable setup (DISABLE). In essence, the signal INTPOR does not go high, preventing an initial resetting of the device.

This is what can occur if the critical nodes in the POR circuit are not fully discharged.

In the power-on condition, the signal INTPOR is equal to the ground reference gnd, the signal EN is equal to the threshold voltage of an NMOS transistor Vthn, and the signal EN_N is equal to a voltage Vdd-Vthp, where Vthp is a threshold voltage of a PMOS transistor.

As the supply voltage Vdd goes down, the following occurs.

The additional transistor M51 of the inverter I1 turns off almost at once because Vsg(M5 1)<Vthp, while the transistor M52 of the inverter I1 is already off. Thus, the node C is allowed to float. The parasitic capacitive coupling between the node C and the supply reference Vdd, through transistor M50, causes the signal EN_N to go low at said node as the supply voltage Vdd decreases. However, this signal EN_N stays positive.

Likewise the parasitic capacitive coupling between the node B and the supply reference Vdd, through transistor M53, causes the signal EN to go low at said node as the supply voltage Vdd decreases. However, since this signal EN is already at a low value, it will tend to go negative. When this occurs, the transistor M54 turns off and does not oppose the downward trend of the signal EN.

Without the additional transistors M51 and M54, i.e., using traditional inverters, the effect would be similar but less intense. In traditional inverters the signal EN is equal to the ground reference gnd, and the signal EN_N slightly positive because the transistor M50, to which a voltage Vdd<Vthp is applied, would be turned off.

Clearly, if the digital device is held in the off state (voltage Vdd=0) for a sufficiently long time, eventually all nodes, including the critical ones, would be discharged. However, experimental evidence points to standard POR circuits keeping the signal EN_N positive and signal EN null or negative for a relatively long time, that may be a matter of seconds.

Thus, as the voltage Vdd is again raised, the node A cannot rise at an adequately fast rate to discharge the node C, while said node C holds the node B low for a sufficient length of time. The chain of events (initializing/switching) that bring the signals INTPOR and EN to a low, and the signal EN_N to a high, is therefore initiated.

### SUMMARY OF THE INVENTION

An embodiment of this invention provides a circuit, adapted to discharge critical nodes in a digital device upon removal of the supply voltage Vdd, with structural and functional features appropriate to produce, at the next power-on of the circuit, a starting setup that is predetermined by the known behavior, and in this way the drawbacks of prior art circuits are overcome.

A principle on which this invention stands provides the circuit with a supply voltage storing capacitor, adapted to store up charge during normal operation and use this stored up charge to drive suitable node discharging devices as the supply voltage goes low.

The features and advantages of a circuit according to this invention will be apparent from the following description of an embodiment thereof, given by way of non-limitative example with reference to the accompanying drawings.

### BRIEF DESCRIPTION OF THE DRAWINGS

FIG. 1 schematically shows a detail of a POR (Power-On Reset) circuit.

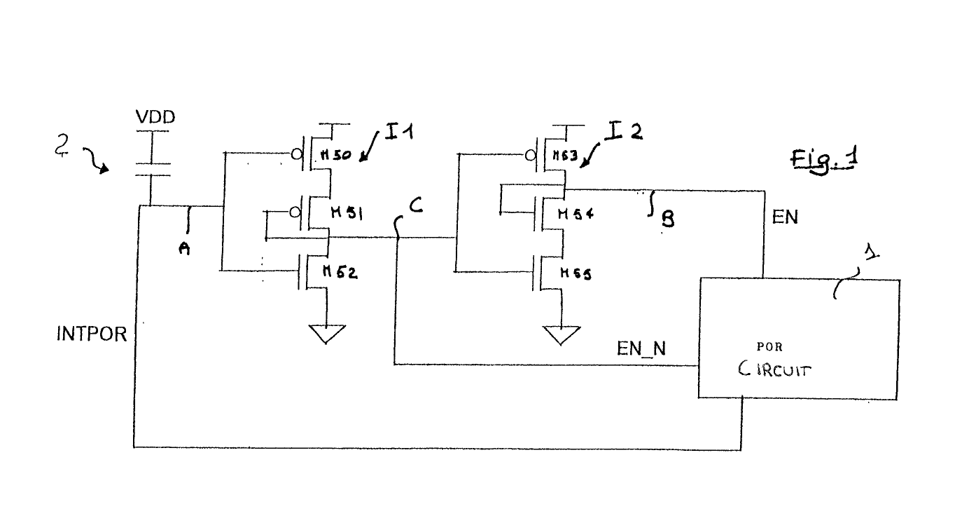

FIG. 2 schematically shows a control circuit according to the invention.

### DETAILED DESCRIPTION OF THE INVENTION

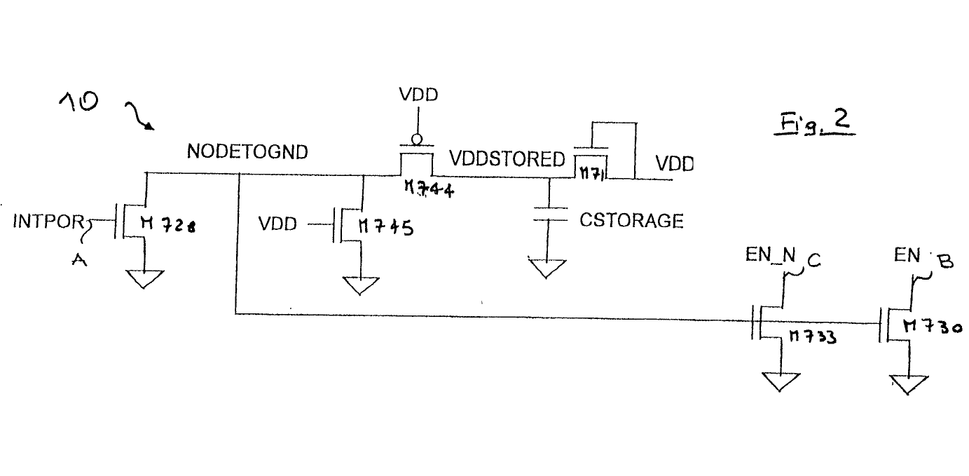

Shown in FIG. 2 of the drawings is an electronic circuit 10 for controlling voltages at critical nodes of an electronic system. Advantageously, such a system is supplied even after the supply voltage is removed.

The circuit 10 comprises a capacitor CSTORAGE, connected between an internal voltage node VDDSTORED and a further voltage reference, in particular a ground reference GND.

The circuit 10 also comprises an NMOS transistor M71 in the diode configuration, ie., having its gate terminal connected to its drain terminal and being inserted between a supply reference Vdd and the node VDDSTORED.

A second transistor M744 has its conduction terminals connected between the node VDDSTORED and a further internal node NODETOGND, and has a gate terminal connected to the supply voltage reference Vdd.

The circuit 10 further comprises third and fourth NMOS transistors M745 and M728, connected between the node NODETOGND and ground GND. The gate terminal of the transistor M745 is input the supply voltage Vdd, and the gate terminal of the transistor M728 is input a signal INTPOR.

Advantageously, the circuit 10 comprises two NMOS transistors M733 and M730 having their source terminals connected to the ground voltage and their gate terminals connected to the node NODETOGND.

In particular, the drain terminal of the transistor M733 is input the signal EN_N, and the drain terminal of the transistor M730 is input the signal EN.

The operation of the circuit 10 will now be described.

With the voltage Vdd at its rated value, the capacitor CSTORAGE is charged up to a voltage Vdd−Vthn, where Vthn is the threshold voltage of an NMOS transistor.

Briefly, this is due to the transistor M71 serving the function of a unidirectional charging device. In fact, this device M71 could be replaced with a diode.

It should be noted that, besides a transitional charge current, the circuit 10 would draw no current at steady state, since the NMOS transistor M71 and the PMOS transistor M744 are held ‘off’ because their gate terminals receive the supply voltage Vdd.

The gate terminal of transistor M745 is input the supply voltage Vdd so that, at steady state, the node NODETOGND is held discharged, while transistor M728 is held ‘off’ because the signal INTPOR is normally low.

Assume now that the supply voltage Vdd begins to lessen: transistor M71 turns off at once, while the node VDDSTORED tends to retain a voltage Vdd*−Vthn, where Vdd* is the rating value of voltage Vdd.

Actually, the capacitive coupling between the node VDDSTORED and the supply voltage reference Vdd tends somewhat to depress the value of the voltage at the node VDDSTORED, but the effect is made trivial by the capacitance of the capacitor CSTORAGE being quite large.

Upon the supply voltage Vdd reaching a value equal to Vdd*−Vthn−Vthp, where Vthp is the value of the threshold voltage of a PMOS transistor, the PMOS transistor M744 turns on, thereby generating an input current to the node NODETOGND. The PMOS transistor M744 essentially operates as a charging device.

On the other hand, if the voltage Vdd is still sufficiently high, transistor M745 is also turned on, and tends to discharge the node NODETOGND, with a low current because this transistor M745 is highly resistive.

There may be either of two situations:

if the voltage Vdd drops at a fast rate, transistor M745 turns off almost at once, and the current from transistor M744 will charge the node NODETOGND to a value close to a voltage Vdd*−Vthn;

if the voltage Vdd drops very slowly, the transistor M745 will stay ‘on’ for a long time and dissipate the charge stored in the node VDDSTORED, although the voltage at the node VDDSTORED cannot drop to a lower value than Vdd+Vthp.

Thus, upon the voltage Vdd dropping below the value of Vthn, causing the transistor M745 to turn off, the value of the voltage at the node VDDSTORED at least equals to Vthn+Vthp, and from this moment onwards, all the current delivered by the transistor M744 will charge the node NODETOGND. Accordingly, with a zero voltage Vdd, the voltage at the node NODETOGND will take a value that the more approaches Vthn+Vthp, the higher becomes the capacitive ratio of the capacitor CSTORAGE to the equivalent capacitor at node NODETOGND.

Summarizing, with the voltage Vdd null, the node NODETOGND will be charged anyway to a value above the threshold Vthn of an NMOS transistor.

Advantageously, the node NODETOGND is used to drive the gate terminals of the MOS transistors M733 and M730, which transistors will begin to conduct and discharge the respective signals EN_N and EN to ground.

Of course, in different circuits, it would be theoretically possible to discharge all the necessary nodes, once the components are dimensioned to suit. With the critical nodes of a device suitably discharged, when the supply voltage Vdd is again turned on, the device will perform as expected.

Advantageously, the node NODETOGND is held low by means of the transistor M728, whose gate terminal, connected to the signal INTPOR, goes high at once.

Furthermore, the transistor M728 is highly conductive and can quickly discharge the node NODETOGND. And as the signal INTPOR goes low again, the transistor M728 turns off, but by that time the weak pull-down provided by the transistor M745 is enough to keep the node NODETOGND discharged.

To summarize, whenever the removal of the supply voltage Vdd causes certain critical nodes to be held at unsuitable values, the nodes must be discharged. This is done by using active components that, however, do require some voltage.

Advantageously in the circuit 10, a charge storage means is used, whose charge will be used to drive the active components only after the supply voltage Vdd is removed.

This circuit utilizes a capacitor for storing said charge (as well as for storing a voltage close to the rated voltage Vdd), and the thresholds of MOS transistors combined with the current value of the supply voltage Vdd in order to determine the moment that this charge is to be released.

Advantageously, besides an acritical dimensioning of components, no circuit calibration is required.

Finally, the power consumption of the inventive circuit is trivial compared to that of the system wherein it is used, since there is but a capacitor to be charged when the circuit is turned on.

From the foregoing it will be appreciated that, although specific embodiments of the invention have been described herein for purposes of illustration, various modifications may be made without deviating from the spirit and scope of the invention. Accordingly, the invention is not limited except as by the appended claims.

We claim:

1. An electronic circuit for controlling voltage signals at particular critical nodes of an electronic device connected to the circuit, said circuit being inserted between a supply voltage reference and a ground voltage reference, said circuit comprising:
an internal reference node connected to said critical nodes;
a charging device connected to said internal reference node; and
a capacitive element connected between said supply voltage reference and said ground voltage reference, and coupled to said internal reference node through said charging device, said capacitive element being charged with said supply voltage reference to maintain, at said internal reference node a voltage value above a predetermined threshold voltage as said supply voltage reference is cut off.

2. An electronic control circuit according to claim 1, wherein said charging device comprises a P-channel MOS transistor having conduction terminals connected to said internal reference node and to said capacitive element respectively, and having a control terminal connected to said supply voltage reference.

3. An electronic control circuit according to claim 1, further comprising a further charging device, being connected between said internal reference node and said ground voltage reference and effective to discharge said node at steady state of the circuit.

4. An electronic control circuit according to claim 3, wherein said further charging device comprises an N-channel MOS transistor having conduction terminals connected to said internal reference node and to said ground voltage reference respectively, and having a control terminal connected to said supply voltage reference.

5. An electronic control circuit according to claim 3, wherein said charging device comprises a highly resistive NMOS transistor.

6. An electronic control circuit according to claim 1, further comprising a further charging device connected between said internal reference node and said ground voltage reference and effective to discharge said internal reference node.

7. An electronic control circuit according to claim 6, wherein said further charging device comprises an N-channel MOS transistor having conduction terminals connected to said internal reference node and to said ground voltage reference respectively, and having a control terminal arranged to receive an external control signal.

8. An electronic control circuit according to claim 1, further comprising a further charging device connected between and said supply voltage reference and said capacitive element.

9. An electronic control circuit according to claim 8, wherein said further charging device comprises a diode-connected N-channel MOS transistor having conduction terminals connected to said supply voltage reference and said capacitive element respectively.

10. An electronic control circuit according to claim 1, wherein said threshold value is selected to lie above a threshold voltage of MOS devices.

11. An electronic control circuit according to claim 1, further comprising a connection device connected between said critical nodes and said ground voltage reference as well as to said internal reference node.

12. An electronic control circuit according to claim 11, wherein said connection device comprises an N-channel MOS transistor having conduction terminals connected to said critical nodes and said ground voltage reference respectively, and having a control terminal connected to said internal reference node.

13. An electronic circuit for controlling a voltage signal at a critical node of an electronic device connected to the circuit, the circuit comprising:
an internal reference node connected to the critical node;
a charge storage device connected between a supply voltage reference and a ground voltage reference; and
a first switch connected between the internal reference node and the charge storage device and having a control terminal connected to the supply voltage reference, the first switch being structured to electrically connect the charge storage device to the internal reference node in response to the supply voltage reference dropping below a threshold, thereby maintaining the internal reference node at a voltage value above a predetermined threshold voltage.

14. The circuit of claim 13 wherein the switch comprises a PMOS transistor having conduction terminals connected to the internal reference node and to the capacitive element respectively.

15. The circuit of claim 13, further comprising a second switch connected between the internal reference node and the ground voltage reference and effective to discharge the node at steady state of the circuit.

16. The circuit of claim 15 wherein the second switch comprises an NMOS transistor having conduction terminals connected to the internal reference node and to the ground voltage reference respectively, and having a control terminal connected to the supply voltage reference.

17. The circuit of claim 15 wherein the further charging device comprises an NMOS transistor having conduction terminals connected to the internal reference node and to the ground voltage reference respectively, and having a control terminal arranged to receive an external control signal.

18. The circuit of claim 13, further comprising a diode-connected second switch connected between and the supply voltage reference and the charge storage device.

19. The circuit of claim 13, further comprising a second connected between the critical node and the ground voltage reference and having a control terminal connected to the internal reference node.

20. A method of controlling a voltage signal at a critical node of an electronic device, the method comprising:
charging a capacitive element to a charging voltage using a supply voltage;
switching the capacitive element into electrical connection with an internal reference node in response to detecting that the supply voltage has dropped below a threshold; and
switching the critical node into electrical connection with a ground voltage reference in response to the internal reference node being switched into electrical connection with the capacitive element.

21. The method of claim 20, further comprising electrically connecting the internal reference node to the ground voltage reference during a steady state in which the supply voltage is above the threshold.
